(19) United States
(12) Patent Application Publication
(10) Pub. No.: US 2025/0230055 A1
(43) Pub. Date: Jul. 17, 2025

(54) MODIFIED TITANIUM DISULFIDE NANOMATERIAL AND ITS PREPARATION METHOD AND APPLICATION

(71) Applicant: China University Of Petroleum - Beijing, Beijing (CN)

(72) Inventors: Jirui HOU, Beijing (CN); Infant RAJ, Beijing (CN); Zhuo LU, Beijing (CN)

(21) Appl. No.: 18/629,173

(22) Filed: Apr. 8, 2024

(30) Foreign Application Priority Data
Jan. 16, 2024 (CN) 202410063313.5

(51) Int. Cl. C01G 23/00; C09K 8/86

(52) U.S. Cl. CPC C01G 23/007; C09K 8/86; C01P 2002/01; C01P 2002/82; C01P 2004/03; C01P 2004/24; C01P 2004/62; C01P 2006/12; C01P 2006/22; C09K 2208/10

(57) ABSTRACT

The present disclosure provides a modified titanium disulfide nanomaterial and its preparation method and application, including the following steps: 1) mixing 1 part by weight of a hydrophilic titanium disulfide nanosheet with 50-200 parts by weight of a ketone compound to obtain a mixture; 2) adding 1-15 parts by weight of an alkylamine compound to the mixture, controlling a pH of the mixture to 4-7, cooling to room temperature after modification reaction, and washing with ethanol, to obtain the modified titanium disulfide nanomaterial; where the number of carbon atoms in the alkylamine compound is C6-C18. The modified titanium disulfide nanomaterial provided by the present disclosure can significantly improve the oil recovery.

### CROSS-REFERENCE TO RELATED APPLICATION

This application claims priority to Chinese Patent Application No. 202410063313.5, filed on Jan. 16, 2024, which is incorporated by reference in its entirety.

### TECHNICAL FIELD

The present disclosure relates to a modified titanium disulfide nanomaterial and its preparation method and application, which belong to the technical field of petroleum exploitation.

### BACKGROUND

The oil extraction process is generally divided into three stages, where primary oil recovery stage mainly relies on the reservoir's own energy (formation pressure, dissolved gas, etc.) to drive the flow of crude oil; with the development of primary oil recovery, the formation pressure is gradually decreased and the pore throat of rock are gradually closed. Therefore, it is urgent to inject fluids into the formation to supplement the formation energy (formation water, gas, etc.), such method that drives out crude oil by supplementing energy is called secondary oil recovery, which is capable of recovering approximately 40% of crude oil; and tertiary oil recovery refers to an oil extraction method of driving out the remaining crude oil by injecting a chemical (such as polymer, gas, nanofluid, and surfactant) into the reservoir. However, owing to the large adsorption loss and high cost of traditional surfactants in the formation, the polymer undergoes serious shear degradation in the reservoir, and the polymer with high viscoelasticity can easily block the pore throat of rock, causing irreversible damage to the reservoir, which is prone to gas channeling and has a low sweep efficiency. These factors seriously limit the application of development materials in traditional oil and gas fields.

At present, nanomaterials are usually used for tertiary oil recovery, the nanomaterials have the characteristics of reducing interfacial tension, changing rock wettability, reducing crude oil viscosity and generating structural separation pressure. Currently, nanomaterials used for oil displacement include graphene, nano-metal oxides, and some nano-nonmetallic oxides. However, the above-mentioned nanomaterials generally have defects such as small specific surface area, high cost, poor dispersion stability, and limited oil recovery improvement effect.

### SUMMARY

In view of the above defects, the present disclosure provides a preparation method of a modified titanium disulfide nanomaterial, a nanofluid prepared from the modified titanium disulfide nanomaterial obtained by the preparation method can significantly improve oil recovery.

The present disclosure provides a modified titanium disulfide nanomaterial prepared according to the above method, where when a hydrophilic titanium disulfide nanosheet contains a hydrophobic alkylamine chain on a surface thereof, the titanium disulfide nanomaterial can effectively reduce an interfacial tension between oil and water, has high dispersion stability, and thus improves the oil recovery.

The present disclosure provides a nanofluid that includes the modified titanium disulfide nanomaterial mentioned above, thereby effectively improving oil recovery and enhancing oil recovery work efficiency.

The present disclosure provides an oil recovery method, including injecting a nanofluid containing a modified titanium disulfide nanomaterial into a reservoir, to achieve the object of improving oil recovery.

The present disclosure provides a preparation method for a modified titanium disulfide nanomaterial, which includes the following steps:
1) mixing 1 part by weight of a hydrophilic titanium disulfide nanosheet with 50-200 parts by weight of a ketone compound to obtain a mixture; and
2) adding 1-15 parts by weight of an alkylamine compound to the mixture, controlling a pH of the mixture to 4-7, cooling to room temperature after modification reaction, and washing with ethanol to obtain the modified titanium disulfide nanomaterial; where the number of carbon atoms in the alkylamine compound is C6-C18.

In the preparation method described above, the number of carbon atoms in the alkylamine compound is C12-C18.

In the preparation method mentioned above, the hydrophilic titanium disulfide nanosheet is mixed with the alkylamine compound at a ratio of 1:1-10 parts by weight.

In the preparation method mentioned above, the hydrophilic titanium disulfide nanosheet is prepared by a method comprising the following processes:
mixing 1 part by weight of a titanium source with 1-10 parts by weight of a catalyst and 10-100 parts by weight of an organic solvent, heating the mixture at 100-150° C. for 0.5-2 hours in an inert gas environment, then raising the temperature to 250-300° C., adding 1-8 parts by weight of a sulfur source, stirring for 1-3 hours, and cooling to room temperature; then the mixture is washed by centrifugation, and filtered to obtain the hydrophilic titanium disulfide nanosheet.

The present disclosure also provides a modified titanium disulfide nanomaterial, which is prepared by the above preparation method.

The modified titanium disulfide nanomaterial mentioned above has a specific surface area of 10-50 m²/g, a layer thickness of 4-15 nm, a length of 300-500 nm, and a width of 170-300 nm.

The present disclosure also provides a nanofluid, including the above modified titanium disulfide nanomaterial and a solvent, wherein the solvent includes one of a saline water and a deionized water.

In the nanofluid mentioned above, a concentration of the modified titanium disulfide nanomaterial is 30-1000 ppm.

In the nanofluid mentioned above, a concentration of the saline water is 10000-220000 mg/L.

The present disclosure provides an oil recovery method for recovering crude oil from a reservoir by the above nanofluid.

The preparation method provided by the present disclosure uses a hydrophilic titanium disulfide nanosheet, a ketone compound, and an alkylamine compound as raw materials to prepare a modified titanium disulfide nanomaterial according to specific addition steps and parts by weight, wherein the number of carbon atoms in the alkylamine compound is C6-C18. The modified titanium disulfide nanomaterial is a hydrophilic titanium disulfide nanosheet grafted with an alkylamine chain on a surface by intermolecular force, where the hydrophilic titanium disulfide nanosheet is hydrophilic and the alkylamine chain is hydrophobic. When the modified titanium disulfide nanomaterial is applied in the nanofluid, under the synergistic effect of the hydrophilic titanium disulfide nanosheet and the alkylamine chain, the oil/water interfacial tension is reduced, thereby improving oil recovery. Moreover, the modified titanium disulfide nanosheet is in the form of flakes; thus, the nanofluid has high oil recovery and stability in the reservoir.

The modified titanium disulfide nanomaterial provided by the present disclosure is prepared according to the above method, and thus, the nanofluid, including the modified titanium disulfide nanomaterial, can significantly improve the oil recovery.

The nanofluid provided by the present disclosure includes the above modified titanium disulfide nanomaterial, and thus, the nanofluid has a low oil/water interfacial tension, which is beneficial for improving oil recovery.

The oil recovery method provided by the present disclosure uses the nanofluid above; thus, the oil recovery method largely solves the problem of low oil recovery in the current tertiary oil recovery process.

### BRIEF DESCRIPTION OF DRAWINGS

FIG. 1 is a SEM image of a modified titanium disulfide nanomaterial prepared in Example 1 of the present disclosure;

FIG. 2 is a high-resolution TEM image of a modified titanium disulfide nanomaterial prepared in Example 2 of the present disclosure;

FIG. 3 is a FTIR spectrogram of a modified titanium disulfide nanomaterial prepared in Example 3 of the present disclosure;

FIG. 4 is a XRD spectrogram of a modified titanium disulfide nanomaterial prepared in Example 4 of the present disclosure;

FIG. 5 is a Raman spectrogram of a modified titanium disulfide nanomaterial prepared in Example 5 of the present disclosure;

FIG. 6 is a curve diagram of interfacial tension-time variation of nanofluids prepared in Examples 9-11 of the present disclosure; and

FIG. 7 is an interfacial tension-oil recovery diagram of all Examples and Comparative Examples of the present disclosure.

### DESCRIPTION OF EMBODIMENTS

To make the objects, technical solutions, and advantages of the present disclosure clearer, the technical solutions in the embodiments of the present disclosure will be described clearly and completely in the following with reference to the examples of the present disclosure. Obviously, the described examples are some examples of the present disclosure but not all of them. Based on the examples in the present disclosure, all other examples obtained by a person skilled in the art without creative labor belong to the scope of protection of the present disclosure.

A first aspect of the present disclosure provides a preparation method for a modified titanium disulfide nanomaterial, which includes the following steps:
1) mixing 1 part by weight of a hydrophilic titanium disulfide nanosheet with 50-200 parts by weight of a ketone compound to obtain a mixture;
2) adding 1-15 parts by weight of an alkylamine compound to the mixture, controlling a pH of the mixture to 4-7, cooling to room temperature after modification reaction, and washing with ethanol to obtain the modified titanium disulfide nanomaterial; where the number of carbon atoms in the alkylamine compound is C6-C18.

Specifically, in step 1), 1 part by weight of the hydrophilic titanium disulfide nanosheet and 50-200 parts by weight of the ketone compound are weighed and mixed, where the ketone compound is adsorbed on a surface of the hydrophilic titanium disulfide nanosheet by an intermolecular force, to obtain the mixture.

The ketone compound in the present disclosure refers to an organic compound containing a carbonyl group, which includes, but is not limited to, N-methylpyrrolidone, N-ethylpyrrolidone, and N-cyclohexylpyrrolidone.

Where in order to fully adsorb the ketone compound on the surface of the hydrophilic titanium disulfide nanosheet, the two can be stirred for fully mixing. The present disclosure does not limit the stirring speed, and an appropriate range can be selected according to an actual situation, such as 50-800 rpm.

The present disclosure does not limit a specific mixing time, which can be selected according to actual conditions, such as 1-4 h.

In step 2), 1-15 parts by weight of the alkylamine compound are added to the above mixture, and the pH of the mixture is controlled to 4-7, where in a weakly acidic environment, the amino group in the alkylamine compound undergoes a nucleophilic addition reaction with the ketone compound adsorbed on the surface of the hydrophilic titanium disulfide nanosheet, causing the surface of the hydrophilic titanium disulfide nanosheet to graft with an alkylamine chain under intermolecular force. After cooling to room temperature, the surface of the resulting solid was washed with ethanol to remove impurities and dried to obtain a modified titanium disulfide nanomaterial.

The alkylamine compound in the present disclosure has a straight chain structure, and the alkylamine compound has a structural formula of CₙH₂ₙ₊₁—NH₂, and the number of carbon atoms in the alkylamine compound is C6-C18, indicating that n is 6-18.

The present disclosure does not limit a specific type of adjuster for pH, and common acidic solvents, such as hydrochloric acid and sulfuric acid, can be selected.

The present disclosure does not limit the reaction temperature and time for nucleophilic addition reaction between the alkylamine compound and the ketone compound. A suitable temperature and time can be selected according to the actual situation; for example, the reaction temperature is 40-80° C. and the time is 1-4 h.

The present disclosure does not limit the times of washing with ethanol, drying time, and temperature, and appropriate ranges can be selected according to the actual situation.

To enable the ketone compound to adsorb on the surface of the hydrophilic titanium disulfide to fully and uniformly react with the alkylamine compound and prevent incomplete reaction due to aggregation, stirring can be used to make the ketone compound fully in contact with the alkylamine compound. The present disclosure does not limit the stirring speed, and an appropriate range can be selected according to the actual situation, such as 50-800 rpm.

The preparation method of the modified titanium disulfide nanomaterial of the present disclosure uses a ketone compound as a linker, to link an alkylamine chain to a surface of a titanium disulfide nanosheet to obtain a modified titanium disulfide nanomaterial, where the number of carbon atoms in the alkylamine chain is 6-18. The modified titanium disulfide nanomaterial obtained by the preparation method of the present disclosure has high dispersion stability and low oil/water interfacial tension, significantly improving the oil recovery. The inventor believes that the improvement of the oil recovery may be attributed to the fact that, on one hand, the ketone compound may adsorb onto the surface of the titanium disulfide nanosheet under intermolecular force, resulting in uniform dispersion between the nanosheets, and then the subsequently added alkylamine compound undergoes the nucleophilic addition reaction with the ketone compound on the surface of the titanium disulfide nanosheet to form the alkylamine chain, and the modified titanium disulfide nanomaterial obtained in this way has high dispersion stability; on the other hand, the alkylamine chain formed by the nucleophilic addition reaction between the ketone compound and the alkylamine compound is hydrophobic and lipophilic and can interact with an oil phase, and the hydrophilic titanium disulfide, which is hydrophilic and lipophobic, can interact with water molecules through hydrogen bonding or other electrostatic interaction, such interaction disrupts the cohesion between water molecules and reduces the interfacial tension between oil and water.

Furthermore, in a specific embodiment of the present disclosure, the number of carbon atoms in the alkylamine compound is C12-C18.

Specifically, the number of carbon atoms in the alkylamine compound is C12-C18. For example, the number of carbon atoms in an alkylamine compound includes, but is not limited to, 12, 13, 14, 15, 16, 17, 18, or a range consisting of any two thereof.

When the number of carbon atoms in the alkylamine compound is within the above range, the hydrophilic property of the titanium disulfide matrix and the hydrophobic property of the alkylamine chain can achieve a good balance; thus, the nanofluid containing the modified titanium disulfide nanomaterial has low oil/water interfacial tension, improving the oil recovery.

Furthermore, in a specific embodiment of the present disclosure, the hydrophilic titanium disulfide nanosheet is mixed with the alkylamine compound in a ratio of 1:1-10 parts by weight.

Specifically, the hydrophilic titanium disulfide nanosheet is mixed with the alkylamine compound in a ratio of 1:1-10 parts by weight. For example, the ratio of the parts by weight between the hydrophilic titanium disulfide nanosheet and the alkylamine compound includes, but is not limited to, 1:1, 1:2, 1:3, 1:4, 1:5, 1:6, 1:7, 1:8, 1:9, and 1:10.

The inventor found that when the hydrophilic titanium disulfide nanosheet is mixed with the alkylamine compound in a ratio of 1:1-10 parts by weight to prepare a modified titanium disulfide nanomaterial, a nanofluid including the modified titanium disulfide nanomaterial has an oil/water interfacial tension of lower than 10⁻¹ mN/m, and use of the nanofluid for recovery of crude oil can significantly improve the oil recovery.

Furthermore, in a specific embodiment of the present disclosure, the hydrophilic titanium disulfide nanosheet is prepared by a method including the following processes:
mixing 1part by weight of a titanium source with 1-10 parts by weight of a catalyst and 10-100 parts by weight of an organic solvent, heating the mixture at 100-150° C. for 0.5-2 hours in an inert gas environment, then raising the temperature to 250-300° C., adding 1-8 parts by weight of a sulfur source, stirring for 1-3 hours, and cooling to room temperature, and then washing by centrifugation, and filtering, to obtain the hydrophilic titanium disulfide nanosheet.

The titanium source of the present disclosure can be selected from at least one of titanium tetrachloride, tetrabutyl titanate, or isopropanol titanium, which are commonly used in art.

The catalyst of the present disclosure is selected from at least one of octadecylamine and a mixture of oleylamine and oleic acid. Where the present disclosure does not limit a ratio of oleylamine to oleic acid in the mixtures of oleylamine and oleic acid. For example, oleylamine and oleic acid may be mixed in a volume ratio of 1:1-4 to obtain a mixture.

The organic solvent used in the present disclosure includes at least one of ethanol and 1-octadecene.

The present disclosure does not limit a specific type of inert gas, which can be selected from nitrogen, helium, argon, or other common types in art.

The sulfur source used in the present disclosure includes at least one of carbon disulfide and sulfur powder.

The preparation method of the hydrophilic titanium disulfide nanosheet provided by the present disclosure has a simple preparation process, high reproducibility, and under the action of a catalyst, the reactants are dispersed more uniformly without aggregation. The prepared hydrophilic titanium disulfide nanosheets have uniform size and morphology, good crystallinity, and high purity, providing a good matrix for the modified titanium disulfide nanomaterial.

The present disclosure also provides a modified titanium disulfide nanomaterial, which is prepared by the above preparation method.

The modified titanium disulfide nanomaterial uses a hydrophilic titanium disulfide nanosheet as a matrix, and a hydrophobic alkylamine chain is grafted onto a surface of the hydrophilic titanium disulfide nanosheet, and when the modified titanium disulfide nanomaterial is applied in a nanofluid, it can significantly reduce an interfacial tension between oil and water, enhance stability, and thus improve oil recovery.

Furthermore, in a specific embodiment of the present disclosure, the modified titanium disulfide nanomaterial has a specific surface area of 10-50 m²/g, a layer thickness of 4-15 nm, a length of 300-500 nm, and a width of 170-300 nm.

The specific surface area of the modified titanium disulfide nanomaterial in the present disclosure refers to an average specific surface area, which is detected by a specific surface area tester.

The layer thickness, length, and width of the modified titanium disulfide nanomaterial refer to average measurements, and the present disclosure does not limit specific measurement methods, and can use common measurement methods in the art.

The specific surface area of the modified titanium disulfide nanomaterial is 10-50 m²/g. For example, the specific surface area includes but is not limited to 10 m²/g, 15 m²/g, 20 m²/g, 25 m²/g, 30 m²/g, 35 m²/g, 40 m²/g, 45 m²/g, 50 m²/g, or a range consisting of any two thereof.

The layer thickness of the modified titanium disulfide nanomaterial is 4-15 nm. For example, the layer thickness includes but is not limited to 4 nm, 5 nm, 6 nm, 7 nm, 8 nm, 9 nm, 10 nm, 11 nm, 12 nm, 13 nm, 14 nm, 15 nm or a range consisting of any two thereof.

The length of the modified titanium disulfide nanomaterial is 300-500 nm. For example, the length includes but is not limited to 300 nm, 320 nm, 340 nm, 360 nm, 380 nm, 400 nm, 420 nm, 440 nm, 460 nm, 480 nm, 500 nm or a range consisting of any two thereof.

The width of the modified titanium disulfide nanomaterial is 170-300 nm. For example, the width includes but is not limited to 170 nm, 180 nm, 200 nm, 220 nm, 240 nm, 260 nm, 280 nm, 300 nm, or a range consisting of any two thereof.

The specific surface area, length, width, and thickness of the modified titanium disulfide nanomaterial are directly related to the specific surface area, length, width, and thickness of the hydrophilic titanium disulfide nanosheet. Thus, the specific surface area and size of the modified titanium disulfide nanomaterial can be controlled by controlling the specific surface area and size of the hydrophilic titanium disulfide nanosheet. In addition, the size of the modified titanium disulfide nanomaterial can be controlled by ultrasonic crushing. Specifically, the dispersion degree of the nanosheet can be changed through ultrasonic crushing, and the higher the dispersion degree, the lesser the aggregation between the nanosheets, and the smaller the size.

When the specific surface area of the modified titanium disulfide nanomaterial is within the above range, an effective contact area between the modified titanium disulfide nanomaterial and an oil/water interface in the reservoir is larger, the interface interaction is greatly enhanced, improving the dispersion stability. And when the size of the modified titanium disulfide nanomaterial is within the above range, the modified titanium disulfide nanomaterial can smoothly pass through a porous medium with low permeability, and has small adsorption loss and good displacement effect, improving the oil recovery.

The present disclosure also provides a nanofluid including the above modified titanium disulfide nanomaterial and a solvent, where the solvent incudes one of a saline water and a deionized water.

Specifically, the modified titanium disulfide nanomaterial is mixed with a solvent to obtain a nanofluid, where the solvent can be saline or deionized water.

The present disclosure has no specific limitation regarding the type of salt compound in saline water. Common salt compounds in art, such as at least one of sodium sulfate, sodium bicarbonate, sodium chloride, calcium chloride, and magnesium chloride, can be selected.

The saline water in the present disclosure can be prepared from a commercially available salt compound with water, or directly using water produced from oilfield extraction to further reduce the production cost.

Because the nanofluid provided by the present disclosure includes the above-mentioned modified titanium disulfide nanomaterial, it has low oil/water interfacial tension and high dispersion stability, significantly improving oil recovery when used for the recovery of crude oil.

Furthermore, in a specific embodiment of the present disclosure, a concentration of the modified titanium disulfide nanomaterial is 30-1000 ppm.

The concentration of the modified titanium disulfide nanomaterial in the nanofluid can be controlled by a mass ratio of the modified titanium disulfide nanomaterial to the solvent. The concentration of the modified titanium disulfide nanomaterial is 30-1000 ppm, for example, the concentration includes but is not limited to 30 ppm, 50 ppm, 100 ppm, 200 ppm, 300 ppm, 400 ppm, 500 ppm, 600 ppm, 700 ppm, 800 ppm, 900 ppm, 1000 ppm, or a range consisting of any two thereof.

When the concentration of the modified titanium disulfide nanomaterial is within the above range, it can not only achieve effective contact between the nanofluid and the crude oil in the reservoir, but also ensure good dispersion of the modified titanium disulfide nanomaterial in the nanofluid, further improving the oil recovery.

Furthermore, in a specific embodiment of the present disclosure, the concentration of saline water is 10000-220000 mg/L.

The concentration of the saline water in the present disclosure can be controlled by adjusting a mass ratio between the salt compound and water, or the saline water can be formulated within the above-mentioned concentration range according to types of different salt compounds.

For example, an aqueous solution of salt prepared according to Table 1.

TABLE 1

| Salt compound | Concentration | |
|---|---|---|
| Na₂SO₄ | 50 | mg/L |
| NaHCO₃ | 90 | mg/L |
| NaCl | 30000 | mg/L |
| CaCl₂ | 6000 | mg/L |
| MgCl₂ | 500 | mg/L |

When the concentration of saline water is within the above range, the adsorption of ions in the saline water on the water-oil interface in the reservoir can be avoided as much as possible and the oil/water interface tension of the nanofluid can be ensured, so that the hydrophilic titanium disulfide matrix and the hydrophobic alkylamine chain have a better synergistic effect, thereby improving the oil recovery.

The present disclosure also provides an oil recovery method, for recovering crude oil from a reservoir by the above-mentioned nanofluid.

Specifically, the above nanofluid is continuously or alternately injected into the reservoir to reduce the interfacial tension between the reservoir and water, improving the oil displacement efficiency and thus enhancing oil recovery and achieving reservoir exploitation.

The nanofluid comprising the modified titanium disulfide nanomaterial of the present disclosure is described in detail through specific examples in the following sections.

### Example 1

In this example, a hydrophilic titanium disulfide nanosheet, modified titanium disulfide nanomaterial, and nanofluid were prepared according to the following steps:
1. preparation of the hydrophilic titanium disulfide nanosheet: mixing 1 part by weight of titanium tetrachloride with 1 part by weight of octadecylamine and 10 parts by weight of 1-octadecene, heating the mixture at 100° C. for 0.5 hour in N₂ environment, then raising the temperature to 250° C., adding 2 parts by weight of carbon disulfide, stirring for 1 hour, cooling to room temperature, and then collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 50 parts by weight of N-methylpyrrolidone, reacting at 50 rpm for 4 hours, then adding 1 part by weight of dodecylamine, controlling the temperature to be 40° C., adjusting a pH to 4 with dilute hydrochloric acid, reacting at 50 rpm for 6 hours, and after cooling to room temperature, washing with ethanol by centrifugation, to obtain a precipitation, i.e., the modified titanium disulfide nanomaterial, which has a specific surface area of 14 m²/g, a layer thickness of 6.8 nm, a length of 325 nm, and a width of 174 nm;
3. preparation of the nanofluid: mixing the obtained modified titanium disulfide nanomaterial with a deionized water, controlling a concentration of the modified titanium disulfide nanomaterial to be 50 ppm per 100 ml of the deionized water, to obtain the nanofluid in this example.

### Example 2

In this example, a hydrophilic titanium disulfide nanosheet, a modified titanium disulfide nanomaterial, and a nanofluid were prepared according to the following steps:
1. preparation of the hydrophilic titanium disulfide nanosheet: mixing 1 part by weight of tetrabutyl titanate, 2 parts by weight of a mixture of oleylamine and oleic acid, and 50 parts by weight of ethanol, heating the mixture at 130° C. for 1 hour in an argon environment, then raising the temperature to 280° C., adding 3 parts by weight of sulfur powder, stirring for 2 hour, cooling to room temperature, and then collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 200 parts by weight of N-cyclohexylpyrrolidone, reacting at 300 rpm for 2 hours, then adding 5 parts by weight of tetradecylamine, controlling a reaction temperature to be 50° C., adjusting a pH to 5 with dilute sulfuric acid, reacting at 300 rpm for 8 hours, and after cooling to room temperature, washing with ethanol by centrifugation, to obtain a precipitation, i.e., the modified titanium disulfide nanomaterial, which has a specific surface area of 15 m²/g, a layer thickness of 5.3 nm, a length of 359 nm, and a width of 185 nm;
3. preparation of the nanofluid: mixing the obtained modified titanium disulfide nanomaterial with a deionized water, controlling a concentration of the modified titanium disulfide nanomaterial to be 50 ppm per 100 ml of the deionized water, to obtain the nanofluid in this example.

### Example 3

In this example, a hydrophilic titanium disulfide nanosheet, a modified titanium disulfide nanomaterial, and a nanofluid were prepared according to the following steps:
1. preparation of the hydrophilic titanium disulfide nanosheet: mixing 1 part by weight of isopropanol titanium, 5 parts by weight of a mixture of oleylamine and oleic acid, and 100 parts by weight of ethanol, heating the mixture at 150° C. for 2 hours in an argon environment, then raising the temperature to 300° C., adding 5 parts by weight of titanium disulfide, stirring for 3 hours, and after cooling to room temperature, collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 80 parts by weight of N-methylpyrrolidone, reacting at 800 rpm for 1 hour, then adding 8 parts by weight of hexadecylamine, controlling the reaction temperature to be 80° C., adjusting a pH to 6 with dilute acetic acid, reacting at 800 rpm for 6 hours, and after cooling to room temperature, washing with ethanol by centrifugation, to obtain the modified titanium disulfide nanomaterial, which has a specific surface area of 21.3 m²/g, a layer thickness of 5.9 nm, a length of 439 nm, and a width of 235 nm;
3. preparation of the nanofluid: mixing the obtained modified titanium disulfide nanomaterial with a deionized water, controlling a concentration of the modified titanium disulfide nanomaterial to be 50 ppm per 100 ml of the deionized water, to obtain the nanofluid in this example.

### Example 4

In this example, a hydrophilic titanium disulfide nanosheet, a modified titanium disulfide nanomaterial, and a nanofluid were prepared according to the following steps:
1. preparation of the hydrophilic titanium disulfide nanosheet: mixing 1 part by weight of isopropanol titanium, 2 parts by weight of octadecylamine and 50 parts by weight of ethanol, heating the mixture at 150° C. for 1 hour in a nitrogen environment, then raising the temperature to 250° C., adding 2 parts by weight of sulfur powder, stirring for 2 hours, and cooling to room temperature, and then collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 50 parts by weight of N-cyclohexylpyrrolidone, reacting at 300 rpm for 2 hours, then adding 10 parts by weight of dodecylamine, controlling the reaction temperature to 60° C., adjusting a pH to 6 with dilute hydrochloric acid, reacting at 300 rpm for 10 hours, and after cooling to room temperature, washing with ethanol by centrifugation, to obtain the modified titanium disulfide nanomaterial, which has a specific surface area of 24 m²/g, a layer thickness of 8.7 nm, a length of 325 nm, and a width of 247 nm;
3. preparation of the nanofluid: mixing the obtained modified titanium disulfide nanomaterial with a deionized water, controlling a concentration of the modified titanium disulfide nanomaterial to be 50 ppm per 100 ml of the deionized water, to obtain the nanofluid in this example.

### Example 5

In this example, a hydrophilic titanium disulfide nanosheet, a modified titanium disulfide nanomaterial, and a nanofluid were prepared according to the following steps:
1. preparation of the hydrophilic titanium disulfide nanosheet: mixing 1 part by weight of isopropanol titanium, 2 parts by weight of a mixture of oleylamine and oleic acid, and 50 parts by weight of ethanol, heating the mixture at 150° C. for 1 hour in a nitrogen environment, then raising the temperature to 250° C., adding 2 parts by weight of sulfur powder, stirring for 2 hours, cooling to room temperature, and then collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 100 parts by weight of N-ethylpyrrolidone, reacting at 300 rpm for 2 hours, then adding 10 parts by weight of dodecylamine, controlling the reaction temperature to be 60° C., adjusting a pH to 6 with dilute sulfuric acid, reacting at 300 rpm for 12 hours, and after cooling to room temperature, washing with ethanol by centrifugation, to obtain the modified titanium disulfide nanomaterial, which has a specific surface area of 14.3 m²/g, a layer thickness of 6.8 nm, a length of 309 nm, and a width of 182 nm;
3. preparation of the nanofluid: mixing the obtained modified titanium disulfide nanomaterial with a deionized water, controlling a concentration of the modified titanium disulfide nanomaterial to be 50 ppm per 100 ml of the deionized water, to obtain the nanofluid in this example.

### Example 6

A hydrophilic titanium disulfide nanosheet and a modified titanium disulfide nanomaterial in this example were prepared in the same methods as in Example 5, whereas a nanofluid was prepared in a different method with details as below:
mixing the modified titanium disulfide nanomaterial with a saline water, a concentration of the saline water being 36640 mg/L and a concentration of the modified titanium disulfide nanomaterial being 50 ppm per 100 ml of the saline water, to obtain the nanofluid in this example.

### Example 7

A hydrophilic titanium disulfide nanosheet and a modified titanium disulfide nanomaterial in this example were prepared in the same methods as in Example 5, whereas a nanofluid was prepared in a different method with details as below:
mixing the obtained modified titanium disulfide nanomaterial with deionized water and controlling the concentration of the modified titanium disulfide nanomaterial to 2000 ppm per 100 ml of deionized water to obtain the nanofluid in this example.

### Example 8

A hydrophilic titanium disulfide nanosheet and a modified titanium disulfide nanomaterial in this example were prepared in the same methods as in Example 5, whereas a nanofluid was prepared in a different method with details as below:
mixing the obtained modified titanium disulfide nanomaterial with a saline water, where a concentration of the saline water is 300000 mg/L and a concentration of the modified titanium disulfide nanomaterial is 50 ppm per 100 ml of the saline water; after which the nanofluid in this example is obtained.

### Example 9

A hydrophilic titanium disulfide nanosheet and a modified titanium disulfide nanomaterial in this example were prepared in the same methods as in Example 5, whereas a nanofluid was prepared in a different method with details as below:
mixing the obtained modified titanium disulfide nanomaterial with a deionized water, with a concentration of the modified titanium disulfide nanomaterial being 60 ppm per 100 ml of the deionized water, to obtain the nanofluid in this example.

### Example 10

A hydrophilic titanium disulfide nanosheet and a modified titanium disulfide nanomaterial in this example were prepared in the same methods as in Example 5, whereas a nanofluid was prepared in a different method with details as below:
mixing the obtained modified titanium disulfide nanomaterial with a deionized water, with a concentration of the modified titanium disulfide nanomaterial being 300 ppm per 100 ml of the deionized water, to obtain the nanofluid in this example.

### Example 11

A hydrophilic titanium disulfide nanosheet and a modified titanium disulfide nanomaterial in this example were prepared in the same methods as in Example 5, while a nanofluid was prepared in a different method with details as below:
mixing the obtained modified titanium disulfide nanomaterial with a deionized water, and controlling a concentration of the modified titanium disulfide nanomaterial to be 600 ppm per 100 ml of the deionized water, to obtain the nanofluid in this example.

### Example 12

A hydrophilic titanium disulfide nanosheet and a nanofluid in this example were prepared using the same method as in Example 5, whereas a modified titanium disulfide nanomaterial was prepared using a different method with the following details:
2. preparation of the modified titanium disulfide nanomaterial: mixing 1 part by weight of the hydrophilic titanium disulfide nanosheet with 100 parts by weight of N-ethylpyrrolidone, reacting at 300 rpm for 2 hours, then adding 10 parts by weight of octylamine, controlling the reaction temperature to be 60° C., adjusting a pH to 6 with dilute hydrochloric acid, reacting at 300 rpm for 12 hours, and after cooling to room temperature, washing with ethanol by centrifugation, to obtain the modified titanium disulfide nanomaterial, which has a specific surface area of 14.3 m²/g, a layer thickness of 6.8 nm, a length of 309 nm, and a width of 182 nm.

### Example 13

A hydrophilic titanium disulfide nanosheet and a nanofluid in this example were prepared in the same methods as in Example 5, whereas a modified titanium disulfide nanomaterial was prepared in a different method with details as below:
2. preparation of the modified titanium disulfide nanomaterial: mixing 1 weight part of the hydrophilic titanium disulfide nanosheet with 100 weight parts of N-ethylpyrrolidone, reacting at 300 rpm for 2 hours, then adding 15 weight parts of dodecylamine, controlling the reaction temperature to be 60° C., adjusting a pH to 6 with dilute sulfuric acid, reacting at 300 rpm for 12 hours, and after cooling to room temperature, washing with ethanol by centrifugation, to obtain the modified titanium disulfide nanomaterial, which has a specific surface area of 14.3 m²/g, a layer thickness of 6.8 nm, a length of 309 nm, and a width of 182 nm.

### Example 14

A hydrophilic titanium disulfide nanosheet in this example was prepared in a different method from Example 5, and a modified titanium disulfide nanomaterial and a nanofluid were prepared in the same methods as in Example 5, with details as below:
1. preparation of the hydrophilic titanium disulfide nanosheet: mixing 1 part by weight of isopropanol titanium, 6 parts by weight of a mixture of oleylamine and oleic acid, and 50 parts by weight of ethanol, heating the mixture at 150° C. for 1 hour in a nitrogen environment, then raising the temperature to 200° C., adding 1 part by weight of sulfur powder, stirring for 2 hours, cooling to room temperature, and then collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 100 parts by weight of N-ethylpyrrolidone, reacting at 300 rpm for 2 hours, then adding 10 parts by weight of dodecylamine, controlling the reaction temperature to be 60° C., adjusting a pH to 6 with dilute sulfuric acid, reacting at 300 rpm for 12 hours, and after cooling to room temperature, washing with ethanol by centrifugation, to obtaining the modified titanium disulfide nanomaterial, which has a specific surface area of 15.91 m²/g, a layer thickness of 7.8 nm, a length of 423 nm, and a width of 276 nm;
3. preparation of the nanofluid: mixing the obtained modified titanium disulfide nanomaterial with a deionized water, and controlling a concentration of the modified titanium disulfide nanomaterial to be 50 ppm per 100 ml of the deionized water, to obtain the nanofluid in this example.

### Example 15

A hydrophilic titanium disulfide nanosheet in this example was prepared in a different method from Example 5, and a modified titanium disulfide nanomaterial and a nanofluid were prepared in the same methods as in Example 5, with details as below:
1. preparation of the hydrophilic titanium disulfide nanosheet: mixing 1 part by weight of isopropanol titanium, 12 parts by weight of a mixture of oleylamine and oleic acid, and 50 parts by weight of ethanol, heating the mixture at 80° C. for 1 hour in a nitrogen environment, then raising the temperature to 200° C., adding 10 parts by weight of carbon disulfide, stirring for 2 hours, cooling to room temperature, and then collecting a precipitation, washing with ethanol by centrifugation, and drying, to obtain the hydrophilic titanium disulfide nanosheet;
2. preparation of the modified titanium disulfide nanomaterial: mixing 1 part by weight of the hydrophilic titanium disulfide nanosheet with 100 parts by weight of N-ethylpyrrolidone, reacting at 300 rpm for 2 hours, then adding 10 parts by weight of dodecylamine, controlling the reaction temperature to be 60° C., adjusting a pH to 6 with dilute sulfuric acid, reacting at 300 rpm for 12 hours, and after cooling to room temperature, washing with ethanol by centrifugation, to obtain the modified titanium disulfide nanomaterial, which has a specific surface area of 9.27 m²/g, a layer thickness of 9.37 nm, a length of 481 nm, and a width of 149 nm;
3. preparation of the nanofluid: mixing the obtained modified titanium disulfide nanomaterial with a deionized water, and controlling a concentration of the modified titanium disulfide nanomaterial to be 50 ppm per 100 ml of the deionized water, to obtain the nanofluid in this example.

### Comparative Example 1

Mixing 1 part by weight of isopropanol titanium, 2 parts by weight of octadecylamine and 50 parts by weight of ethanol, heating the mixture at 150° C. for 1 hour in a nitrogen environment, then raising the temperature to 250° C., adding 2 parts by weight of sulfur powder, stirring for 2 hours, cooling to room temperature, and then collecting a precipitation, washing with ethanol by centrifugation, and drying, to obtain a hydrophilic titanium disulfide nanosheet, which has a specific surface area of 15.97 m²/g, a layer thickness of 8.3 nm, a length of 377 nm, and a width of 192 nm;
mixing the obtained hydrophilic titanium disulfide nanosheet with a deionized water, a concentration of the modified titanium disulfide nanomaterial being 50 ppm per 100 ml of the deionized water, to obtain a nanofluid in this comparative example.

### Comparative Example 2

A hydrophilic titanium disulfide nanosheet and a nanofluid in this Comparative Example were prepared using the same methods as in Comparative Example 1, except that this comparative example further includes the preparation of a modified titanium disulfide nanomaterial with the following details:
mixing 1 part by weight of the hydrophilic titanium disulfide nanosheet, 100 parts by weight of N-methylpyrrolidone, and 10 parts by weight of dodecylamine directly, adjusting a pH to 5 with dilute hydrochloric acid, reacting at 300 rpm for 12 hours, and after cooling to room temperature, washing with ethanol by centrifugation, to obtain a modified titanium disulfide nanomaterial, which has a specific surface area of 15.97 m²/g, a layer thickness of 8.3 nm, a length of 377 nm, and a width of 192 nm;
mixing the obtained modified titanium disulfide nanomaterial with a deionized water, and controlling a concentration of the modified titanium disulfide nanomaterial to be 50 ppm per 100 ml of the deionized water, to obtain the nanofluid in this comparative example.

### Comparative Example 3

A hydrophilic titanium disulfide nanosheet and a nanofluid in this comparative example were prepared in the same methods as in Comparative Example 1, except that this comparative example further includes preparation of a modified titanium disulfide nanomaterial with the following details:
mixing 1 part by weight of the hydrophilic titanium disulfide nanosheet with 10 parts by weight of N-methylpyrrolidone, reacting at 500 rpm for 2 hours, then adding 20 parts by weight of octadecylamine, controlling the reaction temperature to be 60° C., adjusting a pH to 6 with dilute sulfuric acid, reacting at 500 rpm for 12 hours, and after cooling to room temperature, washing with ethanol by centrifugation, to obtain the modified titanium disulfide nanomaterial, which has a specific surface area of 15.97 m²/g, a layer thickness of 8.3 nm, a length of 377 nm, and a width of 192 nm;
mixing the obtained modified titanium disulfide nanomaterial with a deionized water, and controlling a concentration of the modified titanium disulfide nanomaterial to be 50 ppm per 100 ml of the deionized water, to obtain the nanofluid in this comparative example.

### Comparative Example 4

A hydrophilic titanium disulfide nanosheet and a nanofluid in this comparative example were prepared in the same methods as in Comparative Example 1, except that this comparative example further includes preparation of a modified titanium disulfide nanomaterial with the following details:
mixing 1 part by weight of the hydrophilic titanium disulfide nanosheet with 100 parts by weight of N-methylpyrrolidone, reacting at 500 rpm for 2 hours, then adding 10 parts by weight of didodecylamine, controlling the reaction temperature to be 60° C., adjusting a pH to 6 with dilute sulfuric acid, reacting at 500 rpm for 12 hours, and after cooling to room temperature, washing with ethanol by centrifugation, to obtain the modified titanium disulfide nanomaterial, which has a specific surface area of 15.97 m²/g, a layer thickness of 8.3 nm, a length of 377 nm, and a width of 192 nm;
mixing the obtained modified titanium disulfide nanomaterial with a deionized water, and controlling a concentration of the modified titanium disulfide nanomaterial to be 50 ppm per 100 ml of the deionized water, to obtain the nanofluid in this comparative example.

### Test Example

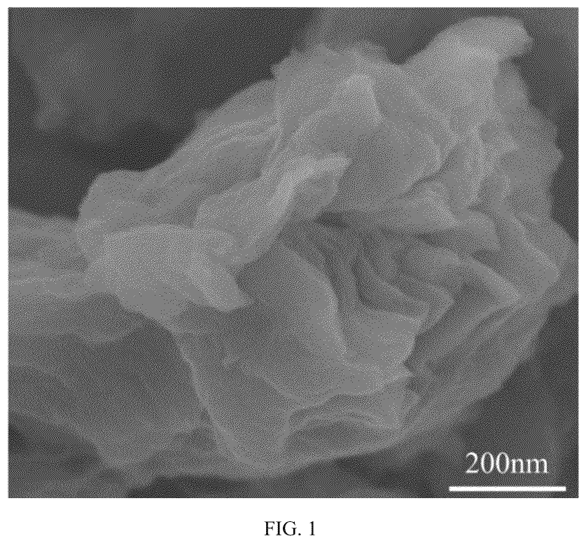

1. SEM test was performed on the modified titanium disulfide nanomaterial prepared in Example 1, and the test results are shown in FIG. 1.

FIG. 1 shows a Scanning Electron Microscopy (SEM) image of the modified titanium disulfide nanomaterial prepared in Example 1, and as shown in FIG. 1, the modified titanium disulfide prepared by the present disclosure is a nanoscale sheet-like nanomaterial.

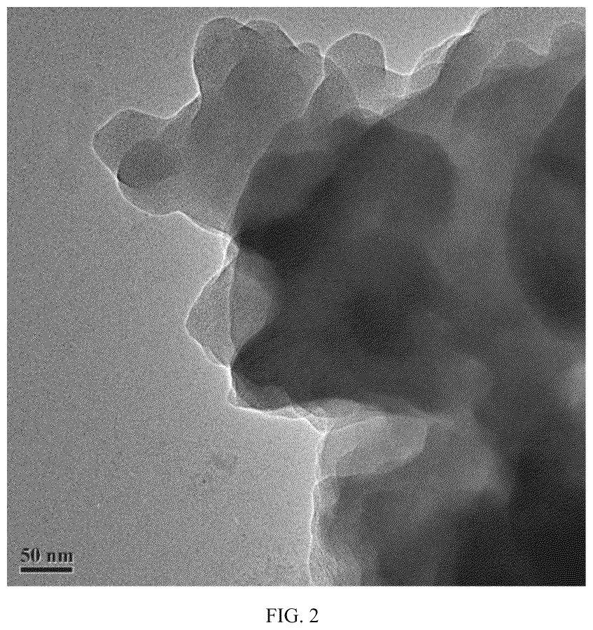

2. TEM test was performed on the modified titanium disulfide nanomaterial prepared in Example 2, and the test results are shown in FIG. 2.

FIG. 2 shows a high-resolution TEM (Transmission Electron Microscopy) image of the modified titanium disulfide nanomaterial prepared in Example 2, and as shown in FIG. 2, the modified titanium disulfide prepared by the present disclosure is a nanoscale sheet-like nanomaterial.

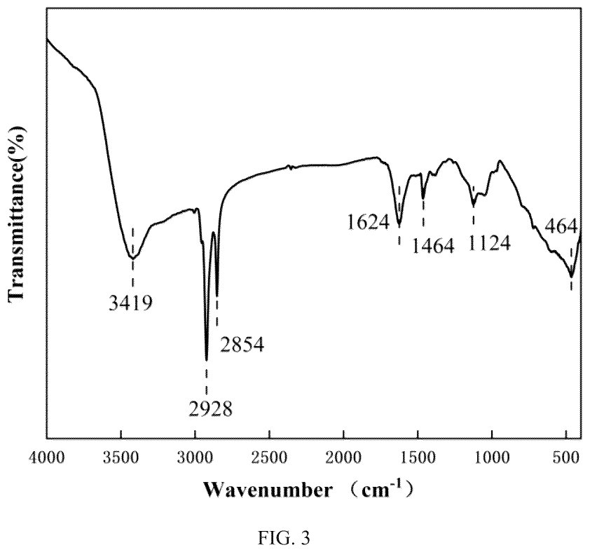

3. FTIR (Fourier Transform Infrared Spectroscopy) was performed on the modified titanium disulfide nanomaterial prepared in Example 3, and the test results are shown in FIG. 3.

FIG. 3 shows a FTIR spectrum of the modified titanium disulfide nanomaterial prepared in Example 3. FTIR is used to further confirm the attachment of alkylamine group to the nanomaterial. According to FIG. 3, a wide peak of 3419 cm⁻¹ is attributed to O—H stretching caused by intermolecular and intramolecular hydrogen bonding, the peaks of 2928 cm⁻¹ and 2854 cm⁻¹ confirm the asymmetric and symmetric stretching vibration of alkyl chain of the alkylamine group, 1624 cm⁻¹ is a vibration peak caused by —OH adsorbed on the surface of the titanium disulfide nanosheet, the vibration band observed at 1464 cm⁻¹ supports the presence of the alkylamine group, which can be attributed to the stretching of C—H alkyl bond. The peak at 1124 cm⁻¹ originates from the C—N stretching of the amide group, while the vibration peak at 462 cm⁻¹ is caused by S—S bonds.

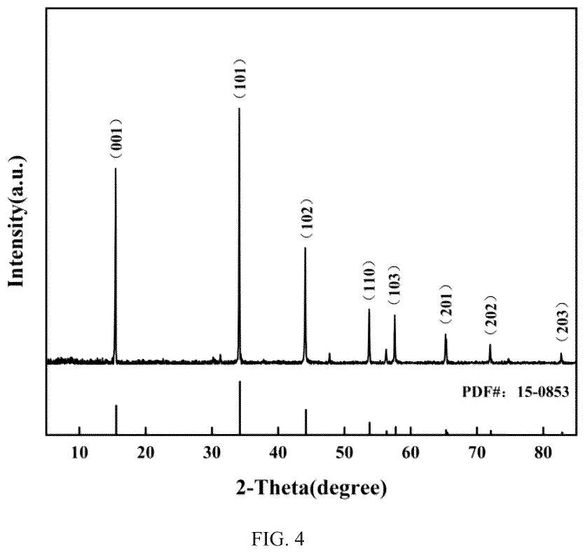

4. X-Ray Diffraction (XRD) tests were performed on the modified titanium disulfide nanomaterial prepared in Example 4, and the test results are shown in FIG. 4.

FIG. 4 shows a XRD spectrum of the modified titanium disulfide nanomaterial prepared in Example 4, and as shown in FIG. 4, the modified titanium disulfide nanomaterial prepared by the present disclosure has good crystallinity when compared with the standard card PDF15-0853 (titanium disulfide).

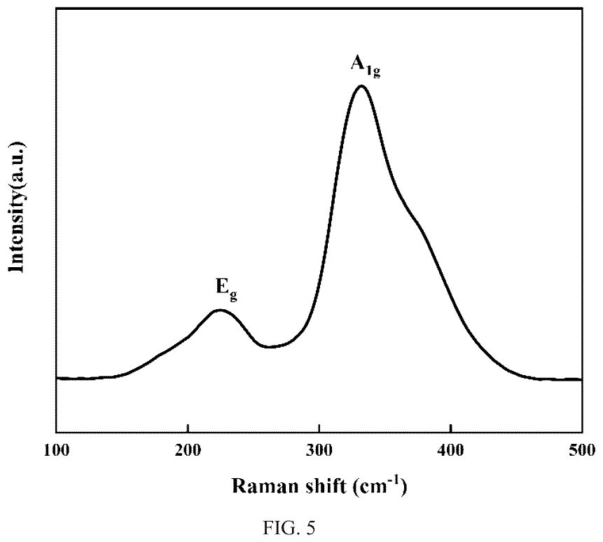

5. The modified titanium disulfide nanomaterial prepared in Example 5 was subjected to Raman spectroscopy test, and the test results are shown in FIG. 5. As shown in FIG. 5, titanium disulfide has two Raman modes at atmospheric pressure, namely Eg and A1_{g}, where Eg represents an in-plane vibration of S atom and A1_{g} represents an out-of-plane vibration of S atom.

### 6. Interface Tension Test

Interfacial tension test was performed on the nanofluids prepared by all the above examples and comparative examples.

The interfacial tension between crude oil and the above nanofluids was measured at 30° C. using a spinning-drop interfacial tensiometer, to obtain a function of the interfacial tension between the two phases over time, with time of 2 hours, and the measurement results were recorded if the measured values were varied within a range of 1-2%.

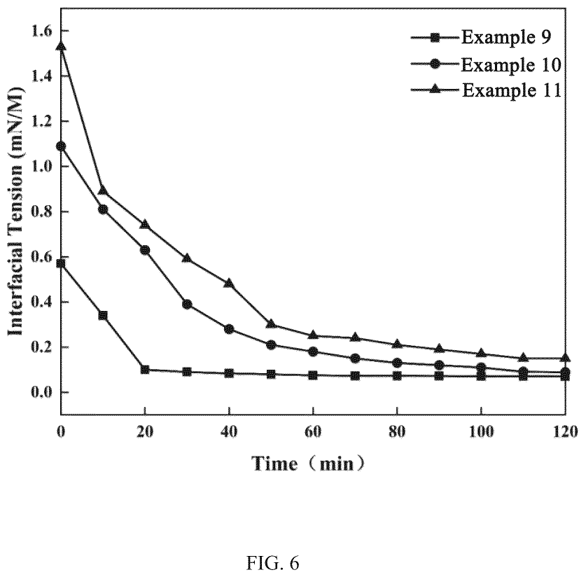

FIG. 6 is a curve graph showing a relationship between interfacial tension and time of the nanofluids prepared in Examples 9-11. According to FIG. 6, when the concentration of the modified titanium disulfide nanomaterial is 50 ppm in 100 ml deionized water, a minimum interfacial tension of 0.07 mN/m is achieved.

### 7. Core Oil Displacement Test

Core oil displacement test was performed on the nanofluids prepared by Examples 1-15 and Comparative Examples 1-4, where sandstone core was used as the core and tested in oil displacement equipment, and the physical properties of core samples are shown in Table 2.

TABLE 2

| | Diameter | Height | Porosity | Permeability |
|---|---|---|---|---|
| | (mm) | (mm) | (%) | (mD) |
| Example 1 | 25.21 | 100.34 | 15.10 | 2.83 |
| Example 2 | 25.13 | 100.29 | 15.90 | 5.31 |
| Example 3 | 25.24 | 100.13 | 14.90 | 2.29 |
| Example 4 | 25.08 | 100.17 | 15.40 | 5.39 |
| Example 5 | 25.09 | 100.09 | 14.12 | 2.68 |
| Example 6 | 25.11 | 100.71 | 15.67 | 5.03 |
| Example 7 | 25.22 | 100.11 | 14.60 | 2.30 |
| Example 8 | 25.18 | 100.70 | 15.80 | 5.60 |
| Example 9 | 25.31 | 100.02 | 16.23 | 5.89 |
| Example 10 | 24.96 | 100.31 | 15.29 | 5.32 |
| Example 11 | 25.37 | 99.87 | 15.91 | 4.93 |
| Example 12 | 25.19 | 99.94 | 14.69 | 4.51 |
| Example 13 | 24.92 | 100.31 | 17.69 | 3.57 |
| Example 14 | 25.18 | 100.13 | 15.79 | 3.41 |
| Example 15 | 25.05 | 99.63 | 14.96 | 2.59 |
| Comparative | 24.97 | 100.03 | 14.37 | 5.24 |
| Example 1 | | | | |
| Comparative | 25.27 | 99.91 | 13.79 | 3.72 |
| Example 2 | | | | |
| Comparative | 25.03 | 100.31 | 15.79 | 2.51 |
| Example 3 | | | | |
| Comparative | 24.89 | 99.96 | 16.27 | 4.89 |
| Example 4 | | | | |

Before starting the crude-oil displacement test, the core was saturated with water for 24 h. Then an oil with viscosity of 100 cP was pumped into the core, until no more water flowed out, and at this time, the core reached an oil saturation state, and a volume of crude oil pumped into the core when the core was saturated can be obtained as V₀. After the oil saturation, water was injected at a rate of 0.3 mL/min until no more oil was recovered, and at this time, a volume of crude oil displaced by water was recorded as V₁; then, the nanofluid was used for oil displacement, with the nanofluid being injected into the core at a rate of 0.3 mL/min until the remaining oil was recovered. The volume of crude oil displaced by the nanofluid was measured and recorded as V₂. The water-displaced oil recovery, nanofluid-displaced oil recovery, and total oil recovery can then be calculated using Equations 1, 2, and 3, respectively:

$$Water - displaced oil recovery ( \% ) = {V}_{1} / {V}_{0} \qquad Equation 1$$

$$Nanofluid - displaced oil recovery ( \% ) = {V}_{2} / {V}_{0} \qquad Equation 2$$

$$Total oil recovery ( \% ) = ( {V}_{1 +} {V}_{2 )} / {V}_{0} \qquad Equation 3$$

The test results are listed in Table 3.

TABLE 3

| | | | Wate- | Nanofluid- | |
|---|---|---|---|---|---|
| | | Oil/water | displaced | displaced | Total |
| | Perme- | interfacial | oil | oil | oil |
| | ability | tension | recovery | recovery | recovery |
| | (mD) | (mN/m) | (%) | (%) | (%) |
| Example 1 | 2.83 | 0.071 | 42.02 | 23.11 | 65.13 |
| Example 2 | 5.31 | 0.07 | 43.64 | 25.45 | 69.09 |
| Example 3 | 2.29 | 0.081 | 41.30 | 21.74 | 63.04 |
| Example 4 | 5.39 | 0.077 | 43.56 | 22.73 | 66.29 |
| Example 5 | 2.68 | 0.071 | 40.73 | 20.37 | 61.10 |
| Example 6 | 5.03 | 0.089 | 44.53 | 20.41 | 64.94 |
| Example 7 | 2.30 | 1.29 | 41.25 | 8.5 | 49.75 |
| Example 8 | 5.60 | 2.33 | 45.63 | 7.32 | 52.95 |
| Example 9 | 5.89 | 0.07 | 45.97 | 25.06 | 71.03 |
| Example 10 | 5.32 | 0.08 | 45.31 | 24.77 | 70.08 |
| Example 11 | 4.93 | 0.2 | 45.29 | 18.35 | 63.64 |
| Example 12 | 4.51 | 0.34 | 44.91 | 16.84 | 61.75 |
| Example 13 | 3.57 | 0.47 | 43.02 | 14.97 | 57.99 |
| Example 14 | 3.41 | 0.84 | 43.23 | 10.11 | 53.34 |
| Example 15 | 2.59 | 1.38 | 42.09 | 8.24 | 50.33 |
| Comparative | 5.24 | 8.29 | 44.35 | 3.27 | 47.62 |
| Example 1 | | | | | |
| Comparative | 3.72 | 2.45 | 42.82 | 6.43 | 49.25 |
| Example 2 | | | | | |
| Comparative | 2.51 | 9.92 | 41.99 | 3.04 | 45.03 |
| Example 3 | | | | | |
| Comparative | 4.89 | 8.37 | 45.04 | 3.38 | 48.42 |
| Example 4 | | | | | |

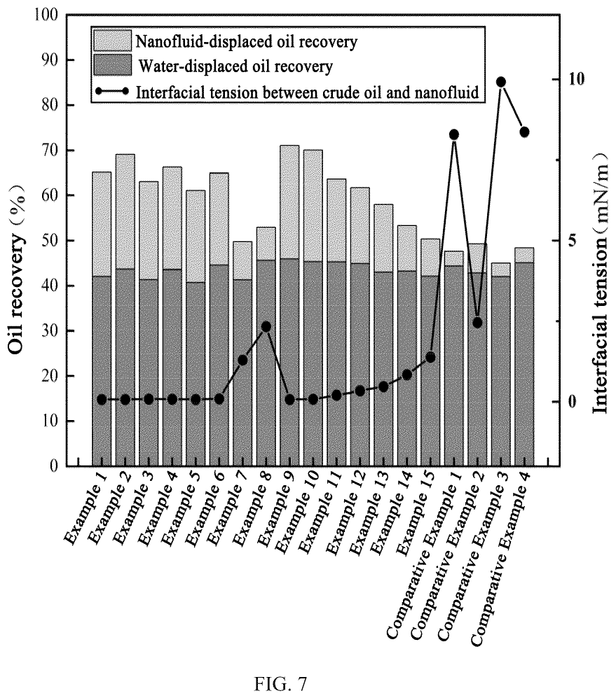

FIG. 7 shows an interfacial tension-oil recovery diagram of Examples 1-15 and Comparative Examples 1-4. According to Table 3 and FIG. 7, it can be seen that the nanofluids prepared in Examples 1-15 have lower oil/water interfacial tensions compared with the nanofluids prepared in Comparative Examples 1-4. Specifically, the oil/water interfacial tensions of the nanofluids prepared in Examples 1-15 were not higher than 2.33 mN/m. When the permeability of the sandstone core is not higher than 5.89 mD, the nanofluid-displaced oil recovery of the nanofluids prepared according to the technical solutions of the present disclosure was not less than 7.32%, and the total oil recovery was not less than 49.75%; and even when the permeability of sandstone core is as low as 2.29 mD, the nanofluid-displaced oil recovery of the nanofluid prepared in Example 3 reached 21.74%, and the total oil recovery reached 63.04%. It can be seen the nanofluids provided by the present disclosure can effectively improve the oil recovery of low-permeability reservoirs.

Finally, it should be noted that the above examples are only used to illustrate the technical solutions of the present disclosure, but not to limit them. Although the present disclosure has been described in detail with reference to the above examples, it should be understood by the skilled in art that the technical solutions described in the above examples can still be modified, or some or all technical features therein can be equivalently replaced. However, these modifications or replacements do not cause the essence of the corresponding technical solutions to deviate from the scope of the technical solutions of various examples of the present disclosure.

What is claimed is:

1. A preparation method of a modified titanium disulfide nanomaterial, comprising the following steps:
1. mixing 1 part by weight of a hydrophilic titanium disulfide nanosheet with 50-200 parts by weight of a ketone compound to obtain a mixture; and
2. adding 1-15 parts by weight of an alkylamine compound to the mixture, controlling a pH of the mixture to 4-7, cooling to room temperature after modification reaction, and washing with ethanol to obtain the modified titanium disulfide nanomaterial;
wherein the number of carbon atoms in the alkylamine compound is C6-C18.

2. The preparation method according to claim 1, wherein the number of carbon atoms in the alkylamine compound is C12-C18.

3. The preparation method according to claim 1, wherein the hydrophilic titanium disulfide nanosheet is mixed with the alkylamine compound in a ratio of 1:1-10 parts by weight.

4. The preparation method according to claim 1, wherein the hydrophilic titanium disulfide nanosheet is mixed with the alkylamine compound in a ratio of 1:1-10 parts by weight.

5. The preparation method according to claim 1, wherein the hydrophilic titanium disulfide nanosheet is prepared by a method comprising the following processes:
mixing 1 part by weight of a titanium source, 1-10 parts by weight of a catalyst and 10-100 parts by weight of an organic solvent, heating the mixture at 100-150° C. for 0.5-2 hours in an inert gas environment, then raising temperature to 250-300° C., adding 1-8 parts by weight of a sulfur source, stirring for 1-3 hours, and cooling to room temperature, and then washing by centrifugation, and filtering, to obtain the hydrophilic titanium disulfide nanosheet.

6. The preparation method according to claim 2, wherein the hydrophilic titanium disulfide nanosheet is prepared by a method comprising the following processes:
mixing 1 part by weight of a titanium source, 1-10 parts by weight of a catalyst and 10-100 parts by weight of an organic solvent, heating the mixture at 100-150° C. for 0.5-2 hours in an inert gas environment, then raising temperature to 250-300° C., adding 1-8 parts by weight of a sulfur source, stirring for 1-3 hours, and cooling to room temperature, and then washing by centrifugation, and filtering, to obtain the hydrophilic titanium disulfide nanosheet.

7. The preparation method according to claim 3, wherein the hydrophilic titanium disulfide nanosheet is prepared by a method comprising the following processes:
mixing 1 part by weight of a titanium source, 1-10 parts by weight of a catalyst and 10-100 parts by weight of an organic solvent, heating the mixture at 100-150° C. for 0.5-2 hours in an inert gas environment, then raising temperature to 250-300° C., adding 1-8 parts by weight of a sulfur source, stirring for 1-3 hours, and cooling to room temperature, and then washing by centrifugation, and filtering, to obtain the hydrophilic titanium disulfide nanosheet.

8. A modified titanium disulfide nanomaterial, which is prepared by the preparation method according to claim 1.

9. The modified titanium disulfide nanomaterial according to claim 8, wherein the number of carbon atoms in the alkylamine compound is C12-C18.

10. The modified titanium disulfide nanomaterial according to claim 8, wherein the hydrophilic titanium disulfide nanosheet is mixed with the alkylamine compound in a ratio of 1:1-10 parts by weight.

11. The modified titanium disulfide nanomaterial according to claim 8, wherein the hydrophilic titanium disulfide nanosheet is prepared by a method comprising the following processes:
mixing 1 part by weight of a titanium source, 1-10 parts by weight of a catalyst and 10-100 parts by weight of an organic solvent, heating the mixture at 100-150° C. for 0.5-2 hours in an inert gas environment, then raising temperature to 250-300° C., adding 1-8 parts by weight of a sulfur source, stirring for 1-3 hours, and cooling to room temperature, and then washing by centrifugation, and filtering, to obtain the hydrophilic titanium disulfide nanosheet.

12. The modified titanium disulfide nanomaterial according to claim 8, wherein the modified titanium disulfide nanomaterial has a specific surface area of 10-50 m²/g, a layer thickness of 4-15 nm, a length of 300-500 nm, and a width of 170-300 nm.

13. The modified titanium disulfide nanomaterial according to claim 9, wherein the number of carbon atoms in the alkylamine compound is C12-C18.

14. The modified titanium disulfide nanomaterial according to claim 10, wherein the hydrophilic titanium disulfide nanosheet is mixed with the alkylamine compound in a ratio of 1:1-10 parts by weight.

15. A nanofluid, comprising the modified titanium disulfide nanomaterial according to claim 8 and a solvent, wherein the solvent comprises one of a saline water and a deionized water.

16. The nanofluid according to claim 15, wherein the modified titanium disulfide nanomaterial has a specific surface area of 10-50 m²/g, a layer thickness of 4-15 nm, a length of 300-500 nm, and a width of 170-300 nm.

17. The nanofluid according to claim 15, wherein a concentration of the modified titanium disulfide nanomaterial is 30-1000 ppm.

18. The nanofluid according to claim 15, wherein a concentration of the saline water is 10000-220000 mg/L.

19. The nanofluid according to claim 17, wherein a concentration of the modified titanium disulfide nanomaterial is 30-1000 ppm.

20. An oil recovery method, comprising recovering crude oil from a reservoir by the nanofluid according to claim 15.
